(19) United States
(12) Patent Application Publication
(10) Pub. No.: US 2004/0037280 A1
(43) Pub. Date: Feb. 26, 2004

(54) Method for multicasting information via at least one communications network

(76) Inventors: Georg Hein, Munchen (DE); Reiner Kolsch, Isen (DE)

Correspondence Address: MORRISON & FOERSTER LLP, 1650 TYSONS BOULEVARD, SUITE 300, MCLEAN, VA, 22102, US

(21) Appl. No.: 10/433,437

(22) PCT Filed: Dec. 4, 2001
(86) PCT No.: PCT/DE01/04545

(51) Int. Cl. H04L 12/28

(52) U.S. Cl. 370/390

(57) ABSTRACT

Multicasting information (vi) is transmitted via at least one communications network (CORE, ACCESS) to a first decentralised communications device (DSLAM1). The multicasting information that has been transmitted is made available for transmission or distribution of at least part of the transmitted multicasting information (vi) to at least one subscriber connection of the first decentralised communications device (DSLAM1). The received multicasting information (vi) is additionally retransmitted to at least one further decentralised communications device (DSLAM2 k). The use of the transmission resources made available by the at least one communications network (CORE, ACCESS) is advantageously optimised in the creation of unidirectional distribution services.

### CLAIM FOR PRIORITY

This application claims priority to the International Application Nos. 1006060123.5 filed Dec. 4, 2000 and 10108401.3 filed Feb. 21, 2001, which is hereby incorporated by reference.

### TECHNICAL FIELD OF THE INVENTION

A system and method for multicasting information via a communication network.

### BACKGROUND OF THE INVENTION

In modern communication networks a number of decentralized communication devices or a number of communication terminals each connected via network terminating devices to the decentralized communication devices are connected via one or more subscriber connection networks or subscriber access networks to a higher-order communication network.

Various transmission methods—e.g. ATM, SDH, PDH, Frame Relay—or a combination of these transmission methods can be used to transmit information in the subscriber access networks and the higher-order communication networks.

Subscriber access networks are configured specifically for connection or access for subscribers to higher-order communication networks and have interfaces with already existing transmission media or specific access interfaces for high bit rate data traffic. Different types of access technologies are known for connecting subscribers in the environment of subscriber connection networks, for example

Connections Via Copper Pairs

Copper pairs already exist in many cases in the home domain. Such pairs can be used with appropriate connection technology to connect subscribers requiring high bit rates—e.g. ATM subscribers. In this context specifically both asymmetrical and symmetrical digital transmission methods—e.g. ADSL, UDSL, VDSL, SDSL—are used, which have a high bandwidth in the subscriber direction. Such transmission methods are also referred to as xDSL transmission methods. Distribution services, in particular multimedia distribution services e.g. radio and TV—and call-up services, for example video on demand or broadband internet communication—e.g. video conferencing—can be created with such connection systems. The use of xDSL transmission methods for connecting subscribers to subscriber access networks is for example described in the publication “XpressLink—Broadband Access with xDLS Technology” Siemens AG, 2000, Information and Communication Networks, D-81359 Munich—pages 8 and 9.

Connections Via Cable TV Lines

The coaxial cable used in the cable TV environment is widespread in the subscriber connection field. Already installed coaxial cables can also be used for the broadband connection of subscribers.

Connections Via Passive Optical Networks (PON)

Optical fiber connections can be taken to the distribution point at the edge of the network—Fiber to the Curb, FTTC—using PONs. From there the information can be transmitted via copper pairs into the building or into the home of the subscriber. With this connection technology fast transmission speeds can be achieved using SDH or PDH transmission technology. The use of optical splitters allows subscriber access networks to be created with widely branched tree structures.

Connections Via Active Optical Networks (AON).

A star-shaped structure with active elements in the forefront of the network—e.g. a cross connect configured according to SDH transmission technology or externally located devices of an ATM switching center—is typical of active optical networks. Active electrical or purely optical amplifier elements can also be used as active elements.

Wireless Connections or Radio Systems

Wireless subscriber connection systems—also referred to as Wireless Local Loop (WLL)—based on point-to-point microwave systems and point-to-multipoint microwave systems are known to the person skilled in the art. Local Multipoint Distribution Systems (LMDS) and Multichannel Multipoint Distribution Systems (MMDS) are also known for the wireless connection of subscribers to the subscriber access network.

The broadband connection of subscribers via subscriber access networks is disclosed in the publication “XpressLink—Broaden your Horizons” Siemens AG 2000, Information and Communication Networks, Hofmannstr. 51, Germany, Order No. A50001-N8-P60-2-7600. The structure of a broadband subscriber access network is for example shown on pages 9 and 10. The subscriber access network depicted shows a number of decentralized communication devices—DSLAM—each with multiplexer and/or concentrator characteristics, to each of which one or more subscribers are connected via network terminating units—NT. The outward data traffic from each subscriber is combined or concentrated by the decentralized communication devices and retransmitted via a standard interface and where necessary via a central access device—in this case ATM Access—to the higher-order communication network—in this case ATM Backbone.

The creation of distribution services via subscriber access networks, for example the distribution of multimedia information—e.g. Video-Broadcast or Video-on-Demand—is known to the person skilled in the art. When creating such distribution services up to now the data to be transmitted—hereafter referred to as the multicasting information—was transmitted from a communication device located centrally in the higher-order communication network—e.g. an ATM switch—a number of times via the subscriber access network or a number of times via separate transmission routes or peripheral lines to the individual decentralized communication devices. The multiple transmission of multicasting information via the subscriber access network in the context of distribution services however represents a waste of transmission resources created by the subscriber access network.

### SUMMARY OF THE INVENTION

The invention discloses an improvement of the creation of distribution services, and in particular, to achieve better use of the transmission resources made available by the subscriber connection networks. The invention is performed by the method, use of the method, by a communication arrangement and by a decentralized communication device for the communication arrangement according to the disclosure herein—below.

In one embodiment of the invention, there is a method in which multicasting information stored in at least one communication network is transmitted via at least one communication network to a first decentralized communication device. The transmitted multicasting information is made available in the first decentralized communication device for transmission or distribution of at least part of the transmitted multicasting information to at least one subscriber connection assigned to the first decentralized communication device. The transmitted multicasting information is also retransmitted to at least one further decentralized communication device.

One advantage of the invention is that the multicasting information to be transmitted, for example, in the context of a distribution service is transmitted once via the at last one communication network or subscriber access network to a first decentralized communication device and is retransmitted from this to any number of further decentralized communication devices. Avoiding multiple transmissions of the same information via the subscriber access network means that the transmission resources made available by the subscriber access network are used optimally. Also moving the distribution functions onto the subscribers' side, i.e. to the decentralized communication device sides, means that no additional arrangement of distribution devices—e.g. SDH multicasting systems—is required in the subscriber access network between the decentralized communication devices and the higher-order communication network. Advantageously compared with the distribution of information via PON connection systems—Passive Optical Networks—there are no restrictions in respect of range and number of the subsequent elements in the distribution tree.

According to another embodiment of the invention, the transmitted multicasting information is also retransmitted in at least some of the further decentralized communication devices to at least one further decentralized communication device. This embodiment means that the invention can be used to set up distribution networks nested to any depth to create distribution services. The respectively nested interconnected decentralized communication devices can be connected to each other to transmit multicasting information via individual peripheral lines with known transmission technology or via one or more communication networks. The communication networks here may be configured according to currently known transmission methods.

Advantageously, the transmitted multicasting information is made available in at least one further decentralized communication device for the transmission or distribution of at least part of the transmitted multicasting information to at least one subscriber connection assigned to at least one further communication device. With this advantageous embodiment of the invention, the multicasting information is made available in the decentralized communication device for internal distribution, i.e. if necessary the multicasting information made available or at least part of it is retransmitted to the respective subscriber connection. It should be noted that a decentralized communication device can also serve (at least temporarily) to retransmit the received multicasting information to the further decentralized communication device connected to it. In this case, the received multicasting information is made available for distribution in the decentralized communication device but is not retransmitted to a subscriber connection. This is the case, for example, when multicasting information has not been requested by any of the subscribers connected to this decentralized communication device.

According to still another embodiment of the invention, the received multicasting information is duplicated or reproduced in the decentralized communication device and then the received or reproduced multicasting information is transmitted almost simultaneously to at least one further decentralized communication device. At least part of the reproduced or received multicasting information is transmitted to at least one subscriber connection assigned to the decentralized communication device. The advantageous duplication or reproduction of the received multicasting information means that there is no need to use expensive switching functions—e.g. ATM switching functions—to create distribution services, so that distribution services can be created with little technical expenditure and therefore particularly economically. Fast reproduction of the multicasting information is advantageously achieved by simply copying the multicasting information to be distributed without using switching functions.

Advantageously, the multicasting information is transmitted more than once almost simultaneously to at least one further decentralized communication device. The quality of the multicasting information transmitted more than once is checked in at least one further decentralized communication device and appropriate multicasting information is selected on the basis of the result of the check from the multicasting information transmitted more than once. This advantageous embodiment means that the multicasting information to be distributed is transmitted redundantly, achieving an increase in error protection during transmission of the multicasting information. For example the data stream best received at each decentralized communication device is identified and retransmitted or distributed accordingly.

The multicasting information can include at least some subscriber-connection-specific multicasting information. In the decentralized communication device subscriber-connection-specific multicasting information is selected from the received or reproduced multicasting information and the selected multicasting information is retransmitted to the corresponding subscriber connection. Subscriber-connection-specific multicasting information may for example represent information addressed to a specific subscriber connection or subscriber, which is selected from the transmitted multicasting information and retransmitted to the correspondingly addressed subscriber connection. This advantageous embodiment means that subscriber-related distribution services such as video on demand can be created, in which different information—e.g. video information—requested by different subscribers is transmitted as a common data stream via the subscriber access network, selected in the decentralized destination communication devices and retransmitted to the respective or requesting subscriber.

According to yet another embodiment of the invention, subscriber-specific useful information is also transmitted to the decentralized communication devices in addition to the multicasting information. The multicasting information and subscriber connection-specific useful information to be transmitted to a subscriber connection is combined in the respective decentralized communication device and the combined information is retransmitted to the respective subscriber connection. Subscriber-related, bi-directional voice and data services for example can be created using the subscriber-connection-specific useful information for example. Multicasting information may also include subscriber-connection-specific multicasting information, with the multicasting and useful information to be transmitted to each specific subscriber connection being combined.

The multicasting information and the subscriber-connection-specific useful information may be transmitted together via at least one communication network to the decentralized communication device, with the information transmitted together being separated in the decentralized communication device and processed further separately. This embodiment may advantageously be used in communication networks supplying high-order transmission resources, with administration costs being minimized for the creation of distribution services.

Alternatively, the subscriber-connection-specific useful information and the multicasting information may be transmitted separately via at least one communication network or via different communication networks to the respective decentralized communication device. For example, the useful information and multicasting information are transmitted separately via communication networks optimally tailored to the information services to be created in each instance, thus further optimizing use of the available transmission resources. Combining the unidirectional multicasting and the bi-directional useful information means that subscriber peripheral lines for unidirectional and bi-directional types of service connected to the respective subscriber connection of the decentralized communication device are shared, thus achieving optimum use of the transmission resources made available.

The multicasting information is transmitted from at least one central communication device located in at least one communication network via at least one communication network to the first decentralized communication device. Advantageously, the multicasting information, which may also include subscriber-connection-specific multicasting information, is stored on different servers in at least one communication network, which may be operated by different operators or program suppliers—also referred to as providers. This embodiment improves the creation of distribution services, as the arrangement of the multicasting information on different servers means that the offering of call-up information is improved and program diversity is enhanced.

Subscriber-connection-specific useful information is advantageously transmitted from at least one further central communication device located in at least one communication network to the respective decentralized communication device. The central communication devices may also be operated by different network operators for example, so that the subscribers connected to the subscriber connections of the decentralized communication devices may be supplied with different types of information or further services by different network operators. The further central communication device may, for example, be a switching device located in the telecommunication network.

According to another embodiment of the invention, the information transmitted to at least one subscriber connection is transmitted using an XDSL transmission method to at least one subscriber assigned to the subscriber connection. Such high transmission bandwidth XDSL transmission methods are particularly suitable for transmitting high bit rate information, such as for example video information, to the connected subscribers.

Alternatively, the information transmitted to at least one subscriber connection is transmitted via at least one peripheral communication network to at least one subscriber assigned to the subscriber connection. All known types of communication network and transmission method may be us ed for this. In particular, additional network components, such as routers, switches or multiplexers, may be used for the subscriber-side switching or distribution of the information or the subscriber-connection-specific information to the subscribers in the peripheral communication network.

Further advantageous embodiments of the invention include a communication arrangement for multicasting information and a decentralized communication device for the communication arrangement.

### BRIEF DESCRIPTION OF THE DRAWINGS

The invention is described in more detail below using two drawings, in which:

FIG. 1 shows a communication network configured as a subscriber access network, which is connected to a higher-order communication network.

FIG. 2 shows an embodiment for connecting decentralized communication devices to the subscriber access network.

### DETAILED DESCRIPTION OF THE INVENTION

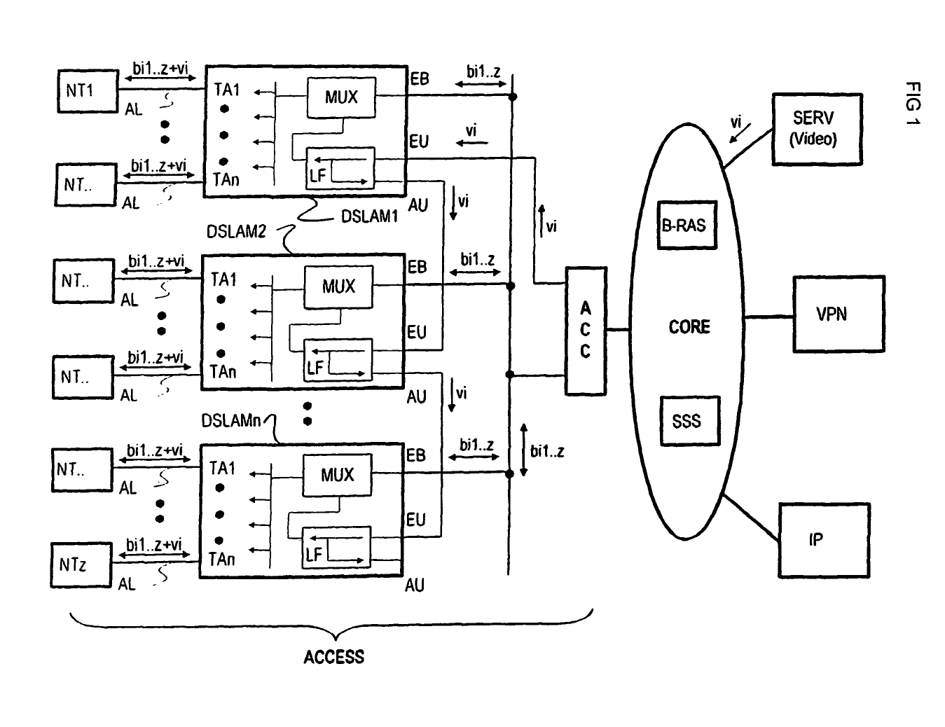

FIG. 1 shows a block circuit diagram of a number of network terminating units NT1 . . . n, which are connected via a subscriber access network ACCESS and via a central access device ACC—also referred to as the access switch—to a higher-order communication network CORE. The higher-order communication network CORE and the central access unit ACC assigned to it are for example configured according to the Asynchronous Transfer Mode—ATM. Further access units—e.g. a Broadband Remote Access Server B-RAS and a Service Selection Server SSS, each indicated by a rectangle—may be located in the higher-order communication network CORE, allowing transition for example to an internet protocol based or IP based communication network IP for the provision of IP based services. A video server SERV is also connected to the higher-order communication network CORE as the central communication device for the creation of a unidirectional distribution service as is an internal company communication network VPN distributed via the communication network CORE.

One or more subscribers or communication terminals assigned to the subscribers—not shown—are connected to each of the individual network terminating units NT1 . . . n. Each of the network terminating units NT1 . . . n is connected via a peripheral line AL to a subscriber connection TA1 . . . n by decentralized communication units DSLAM1 . . . k located in the subscriber access network ACCESS. The decentralized communication devices DSLAM1 . . . k are configured in this embodiment as digital access multiplexers—Digital Subscriber Line Access Multiplexers—which are used to concentrate or multiplex the data traffic sent from or to the subscribers. The information to be transmitted from the subscribers connected to a decentralized communication device DSLAM1 . . . k towards the higher-order communication network CORE is for example multiplexed and retransmitted via a standard interface to the higher-order communication network CORE. The individual subscriber connections TA1 . . . n in conjunction with the peripheral lines AL connected to each of them are configured according to an xDSL transmission method for high bit rate data transmission. Examples of such transmission methods are ADSL, SDSL and VDSL transmission methods.

Each of the decentralized communication devices DSLAM1 . . . k shown in the block circuit diagram has a first input EB and a second input EU, with both inputs EB, EU being fed separately—for example via connections to the subscriber access network Access—to the central access device ACC of the higher-order access network CORE. Bi-directional subscriber-connection-specific voice and data information bi1 . . . z is fed to the first input EB of each decentralized communication device DSLAM1 . . . k to create subscriber-related, bi-directional data services.

According to the invention, the unidirectional multicasting information vi to be distributed via the individual, decentralized communication devices DSLAM1 . . . k is fed to the second input EU. It is assumed for this embodiment that unidirectional video information is to be transmitted as multicasting information vi via the subscriber access network ACCESS to the individual network terminating units NT1 . . . z from the video server SERV located centrally in the higher-order communication network CORE.

According to the invention, the video information vi to be distributed is transmitted as a high bit rate data stream via the higher-order communication network CORE, the central access device ACC and via the subscriber access network ACCESS to the second input EU of the first decentralized communication device DSLAM1. A duplication device LF is located in each decentralized communication device DSLAM1 . . . k and this is connected to the second input EU. The duplication device LF is used to copy or reproduce video information vi fed to the second input EU and to retransmit the reproduced information vi in each instance to a multiplex device MUX located in the respective decentralized communication device DSLAM1 . . . k. The multiplex device MUX is also connected to the first input EB, to which the subscriber-connection-specific, bi-directional voice and data information bi1 . . . z is fed. The multiplex device MUX is used to combine or multiplex the video information vi to be transmitted to each subscriber connection TA1 . . . n and the corresponding subscriber-connection-specific voice and data information bi1 . . . z and retransmit it to the respective subscriber connection TA1 . . . n. The retransmitted, combined information bi1 . . . z+vi is transmitted from the respective subscriber connections TA1 . . . n in a known manner according to an xDSL transmission method to the respective network terminating units NT1 . . . z.

The duplication device LF located in each decentralized communication device DSLAM1 . . . k is connected according to the invention to a further output AU of the decentralized communication device DSLAM1 . . . k. The copied unidirectional video information vi is retransmitted via this output AU to the second input EU of a second decentralized communication device DSLAM2 provided for the inventive distribution of the unidirectional video information. The video information vi fed to the second input EU of the second decentralized communication device DSLAM2 is copied as described above, combined where necessary with the corresponding subscriber connection-specific voice and data information bi1 . . . z and retransmitted to the respective subscriber connections TA1 . . . n. The copied video information vi is also retransmitted via an output AU to the second input EU of a third or nth decentralized communication device DSLAMn.

It should be noted that the video information vi transmitted to the decentralized DSLAM1 . . . k may also include subscriber-connection-specific video information. One example is the video on demand system, in which different video information is requested by different subscribers. This video information addressed to different subscribers or subscriber connections is transmitted or distributed as a common unidirectional data stream vi as described to the individual decentralized communication devices DSLAM1 . . . k. Selection means located specifically in the decentralized communication devices DSLAM1 . . . k select the subscriber-connection-specific video information relevant to the respective subscribers or addressed subscriber connections from the video information vi transmitted to each decentralized communication device DSLAM1 . . . k and combine it where necessary, as already described, with the corresponding subscriber-connection-specific voice and data information bi1 . . . z. The video information addressed to a subscriber may for example be selected using known switching functions—e.g. ATM switching functions—with the selection not being made until after reproduction of the transmitted video information vi according to the invention.

The duplication devices LF located in the individual decentralized communication devices DSLAM1 . . . k may for example be configured as simple copying devices, which copy 1:1 or 1:n and retransmit accordingly the video information vi fed to them. Advantageously no switching functions are required for the purposes of the copying functions in the duplication devices LF so that distribution of the unidirectional video information vi can be achieved with little technical outlay and optimized with regard to speed. According to the invention, the video information vi is distributed without recourse to switching functions—e.g. without using ATM multicasting functions, which can only be implemented at high cost—resulting in extremely fast distribution of the video information vi via the decentralized communication devices.

Connections via the subscriber access network ACCESS may be linked to the two inputs EB, EU of the decentralized communication device DSLAM1 . . . k for example via bi-directional interfaces. This advantageous connection variant is described in more detail below.

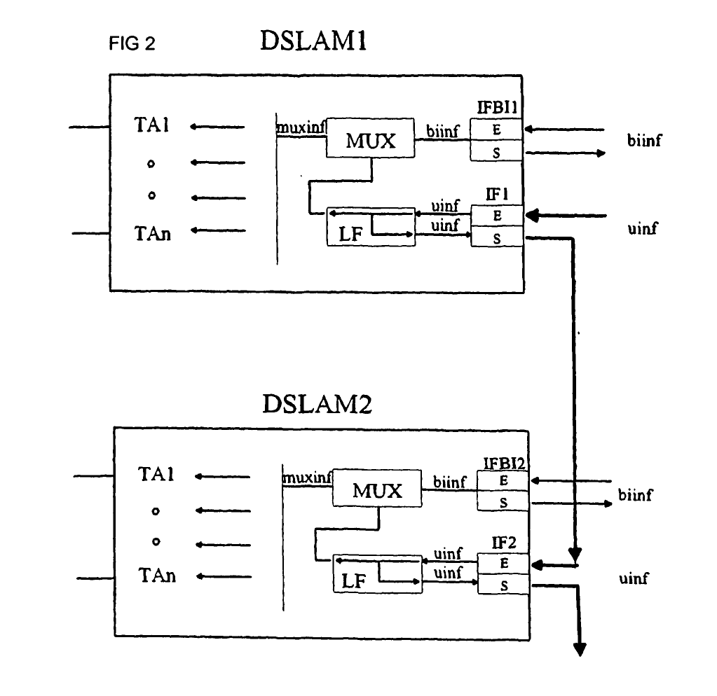

FIG. 2 shows a block circuit diagram of two decentralized communication devices DSLAM1 and DSLAM2 of identical structure, each of which is configured with two bi-directional interfaces. The interfaces have a transmitter S and a receiver E. One of the interfaces is used in each instance for the bi-directional exchange of information biinf with at least one communication device—not shown in the figure—and one is used for the unidirectional transmission of information unif. The bi-directional interfaces provided for unidirectional information transmission are designated as IF1 and IF2 and those for the bi-directional exchange of information as IFB11 and IFB12. In the case of the interfaces IF1 and IF2 used for unidirectional information streams, the receiver E and transmitter S are connected to each other, so that the information received by the receiver E of the interfaces can be forwarded to the transmitter S of the respective interface for retransmission. The transmitter S is connected to the receiver E of a further communication device for the unidirectional transmission of information. In the figure the unidirectional transmission between the communication devices DSLAM1 and DSLAM2 is clarified by way of an example. The information is first transmitted from the receiver E of the unidirectional interface IF1 to the transmitter S and from there to the receiver E of the interface IF2.

In the event of the transmission of information from the receiver E to the transmitter S of a communication device DSLAM1 or DSLAM2 the information may be duplicated by means of a duplication device LF for further use, as indicated in the duplication device LF by the branched arrow for the information stream leaving from the receiver. In the simplest instance, the information is duplicated by means of a branched cable with two output lines. The duplicated information is combined in a multiplex device MUX with information (biinf) transmitted to the interface IFBI1 or IFBI2 for the bi-directional exchange of information. The combined information muxinf is for example fed to subscriber connections TA1 . . . TAn, from where it may be transmitted to subscriber terminals—not shown in the figure. The information transmitted to subscriber terminals undergoes a selection process, which is influenced by control information transmitted from the subscriber terminal, in other words the information is selected in a manner which is specific to the subscriber terminal.

Using conventional bi-directional interfaces for unidirectional connections is low cost and efficient. It is also advantageous that unidirectional and bi-directional information transmission can be achieved with the same bidirectional interfaces. Interfaces integrated in communication devices can therefore be used as required for unidirectional or bi-directional transmission.

The inventive multicasting of multicasting information has the advantage that the video information vi to be transmitted in the context of a distribution service, for example in the context of a video distribution service only has to be transmitted once from the higher-order communication network CORE via the subscriber connection network ACCESS to the first decentralized communication device DSLAM1. The video information vi to be transmitted is then copied or reproduced on the side of the respective decentralized communication devices DSLAM1 . . . k and then forwarded to the next decentralized communication devices DSLAM1 . . . k connected to it. The individual decentralized communication devices DSLAM1 . . . k located in the subscriber access network ACCESS may be linked both in a star shape and one behind the other—also referred to as a “daisy chain”—thus creating a distribution structure for creating distribution services, which may be distributed in any way or nested to any depth.

The separate transmission of the bi-directional, subscriber-connection-specific voice and data information bi1 . . . z and the unidirectional video information vi via the subscriber access network ACCESS means that only a small bandwidth is required on the bi-directional transmission path to each decentralized communication device DSLAM1 . . . k. The possible separation of existing bi-directional data services from unidirectional distribution services means that future broadband distribution services, in particular broadband multimedia services, such as video on demand for example, can be integrated easily and economically into existing subscriber access networks ACCESS or existing subscriber access networks ACCESS can be retrofitted accordingly.

Despite the separate transmission of bi-directional and unidirectional information bi1 . . . z, vi via the subscriber access network ACCESS, the peripheral lines AL1 . . . n in the direction of the subscriber are shared for both unidirectional and bi-directional services.

According to another embodiment—not shown—the bi-directionally oriented voice and data information bi1 . . . z and the unidirectionally oriented multicasting information vi may be transmitted to the first decentralized communication unit DSLAM1 via a common transmission route, tailored for example for high bit rate data transfers, with the bi-directionally oriented voice and data information bi1 . . . z being separated from the unidirectionally oriented multicasting information vi in the first decentralized communication unit and further processed accordingly.

What is claimed is:

1. A Method for multicasting information via at least one communication network, comprising:
transmitting the multicasting information stored in at least one communication network via at least one communication network to a first decentralized communication device, in which the transmitted multicasting information is made available in the first decentralized communication device for transmission or distribution of at least part of the transmitted multicasting information to at least one subscriber connection assigned to the first decentralized communication device; and
retransmitting the transmitted multicasting information to at least one further decentralized communication device, wherein
the multicasting information includes at least some subscriber-connection-specific multicasting information,
the subscriber-connection-specific multicasting information is selected from the multicasting information made available in the first decentralized communication device and the selected multicasting information is retransmitted to the corresponding subscriber connection.

2. The method according to claim 1, wherein the transmitted multicasting information is also retransmitted to at least one further decentralized communication device in at least some of the further decentralized communication devices.

3. The method according to claim 1, wherein the transmitted multicasting information is made available in at least one further decentralized communication device for transmission or distribution of at least part of the transmitted multicasting information to at least one subscriber connection assigned to at least one further decentralized communication device.

4. The method according to claim 1, wherein
the received multicasting information is duplicated or reproduced in the decentralized communication device,
the received or reproduced multicasting information is transmitted almost simultaneously to at least one further decentralized communication device, and
at least part of the reproduced or received multicasting information is transmitted to at least one subscriber connection assigned to the decentralized communication device.

5. The method according to claim 1, wherein
the multicasting information is transmitted more than once almost simultaneously to at least one further decentralized communication device,
the quality of the multicasting information transmitted more than once is checked in at least one further decentralized communication device, and
corresponding multicasting information is selected from the multicasting information transmitted more than once based on the result of the check.

6. The method according to claim 1, wherein
the multicasting information includes at least some subscriber-connection-specific multicasting information, and
the subscriber-connection-specific multicasting information is selected from the received or reproduced multicasting information in the decentralized communication device and the selected multicasting information is retransmitted to the corresponding subscriber connection.

7. The method according to claim 1, wherein
subscriber-connection-specific useful information is also transmitted to the decentralized communication device in addition to the multicasting information,
the multicasting information to be transmitted to a subscriber connection and subscriber-connection-specific useful information are combined in the respective decentralized communication device and the combined information is retransmitted to the respective subscriber connection.

8. The method according to claim 7, wherein the multicasting information and the subscriber-connection-specific useful information are transmitted together via at least one communication network to the decentralized communication device, with the information transmitted together being separated in the decentralized communication device and further processed separately.

9. The method according to claim 7, wherein the multicasting information and the subscriber-connection-specific useful information are transmitted separately via at least one communication network or via different communication networks to the decentralized communication device.

10. The method according to claim 1, wherein the multicasting information is transmitted in the form of one or more unidirectionally oriented data streams via at least one communication network.

11. The method according to claim 1, wherein at least one communication network is configured according to a communication network corresponding to the synchronous or plesiochronous digital hierarchy or as a passive optical communication network and/or according to a packet-based and/or cell-based communication network.

12. The method according to claim 11, wherein at least one communication network is configured according to the Asynchronous Transfer Mode or according to Frame Relay or as a TCP/IP-compliant or as an Ethernet-compliant communication network or as a combination of at least two of the communication networks.

13. The method according to 7, wherein the decentralized communication device represents a multiplex device, with the multicasting information and the subscriber-connection-specific useful information to be transmitted to at least one subscriber connection of the decentralized communication device being multiplexed and the multiplexed information being retransmitted to at least one subscriber connection.

14. The method according to claim 1, wherein the multicasting information is transmitted in a star shape and/or in the form of a daisy chain structure to at least one further decentralized communication device.

15. The method according to claim 1, wherein the multicasting information is transmitted from at least one central communication device located in at least one communication network via at least one communication network to the first decentralized communication device.

16. The method according to claim 7, wherein the subscriber-connection-specific useful information is transmitted from at least one further central communication device located in at least one communication network via at least one communication network to the respective decentralized communication device.

17. The method according to claim 7, wherein the information transmitted to at least one subscriber connection is transmitted using an xDSL transmission method to at least one subscriber assigned to the subscriber connection.

18. The method according to claim 7, wherein the information transmitted to at least one subscriber connection is transmitted via at least one peripheral communication network to at least one subscriber assigned to the subscriber connection.

19. The method according to claim 18, wherein at least one subscriber connection and at least one peripheral communication network are configured according to a communication network corresponding to the synchronous or plesiochronous digital hierarchy or as a passive optical communication network and/or according to a packet-based and/or cell-based communication network.

20. The method according to claim 19, wherein at least one subscriber connection and at least one peripheral communication network are configured according to the Asynchronous Transfer Mode or according to Frame Relay or as a TCP/IP-compliant or an Ethernet-compliant communication network or as a combination of these communication networks.

21. The method according to claim 1, wherein the method is used to create call-up services or multimedia distribution services, in which multimedia information is transmitted as multicasting information via at least one communication network.

22. The method according to claim 21, with the multimedia information including voice and/or video information.

23. A communication arrangement for multicasting information via at least one communication network, comprising:
a first unit located in the communication network for transmitting the multicasting information from at least one central communication device to a first decentralized communication device; and
a second unit located in the first decentralized communication device for making available the transmitted multicasting information for the transmission or distribution of at least part of the transmitted multicasting information to at least one subscriber connection assigned to the first decentralized communication device, and for retransmission of the received multicasting information to at least one further decentralized communication device connected to the first decentralized communication device.

24. The communication arrangement according to claim 23, wherein a third unit is provided in at least part of at least one further decentralized communication device, which is used to retransmit the transmitted multicasting information also to at least one further decentralized communication device.

25. The communication arrangement according to claim 23, wherein a third unit is located in at least one further decentralized communication device for making available the transmitted multicasting information for the transmission or distribution of at least part of the transmitted multicasting information to at least one subscriber connection assigned to the first decentralized communication device.

26. The communication arrangement according to claim 23, further comprising a copying unit for duplicating or reproducing the received multicasting information are located in the decentralized communication device, and a third unit for substantially simultaneous retransmission of the multicasting information or the reproduced multicasting information to at least one further decentralized communication device and for retransmitting at least part of the reproduced or received multicasting information to at least one subscriber connection of the decentralized communication device and are provided in the decentralized communication device.

27. The communication arrangement according to claim 23, further comprising a detection device for detecting subscriber-connection-specific multicasting information included in the received multicasting information are located in the decentralized communication device, the detection device configured so that the subscriber-connection-specific multicasting information in the received or reproduced multicasting information is detected, selected and the selected multicasting information is retransmitted to at least one corresponding subscriber connection.

28. The communication arrangement according to claim 23, further comprising:
an additional receiving device located in the decentralized communication device for receiving subscriber connection-specific useful information; and
a device provided in the decentralized communication device, by means of which the multicasting information to be transmitted to a subscriber connection of the decentralized communication device or the selected multicasting information and the subscriber-connection-specific useful information are combined and the combined information is retransmitted to the respective subscriber connection.

29. The communication arrangement according to claim 28, wherein the device for combining is configured as a multiplexer, by means of which the multicasting information to be transmitted to at least one subscriber connection of the decentralized communication device or the selected multicasting information and at least part of the subscriber-connection-specific useful information are multiplexed and the multiplexed information is retransmitted to at least one subscriber connection.

30. The communication arrangement according to claim 23, wherein the at least one subscriber connection assigned to the decentralized communication device is configured according to an xDSL transmission technology, with the information to be transmitted to at least one subscriber connection being transmitted via a peripheral line using an xDSL transmission method to a network terminating device assigned to the subscriber connection.

31. The communication arrangement according to claim 23, wherein at least one peripheral communication network is connected to at least one subscriber connection assigned to the decentralized communication device, with an option of connecting one or more subscribers to the subscriber connection via at least one peripheral communication network.

32. The communication arrangement according to claim 31, wherein at least one subscriber connection and at least one peripheral communication network are configured according to a communication network corresponding to the synchronous or plesiochronous digital hierarchy or as a passive optical communication network and/or according to a packet-based and/or cell-based communication network.

33. The communication arrangement according to claim 32, wherein at least one subscriber connection and at least one peripheral communication network are configured according to the Asynchronous Transfer Mode or according to Frame Relay or as a TCP/IP-compliant or an Ethernet-compliant communication network or as a combination of at least some of these communication networks.

34. The communication device for a communication arrangement according to claim 23, wherein the first decentralized communication device comprises:
at least one subscriber connection assigned to the first decentralized communication device;
a receiving unit for receiving multicasting information transmitted via at least one communication network to at least one first input of the first decentralized communication device;
a distribution unit for making available the received multicasting information for the transmission or distribution of at least part of the transmitted multicasting information to at least one subscriber connection assigned to the first decentralized communication device, and for the additional retransmission of the received multicasting information to at least one output of the first decentralized communication device, with an option of connecting at least one additional decentralized communication device to at least one output for the retransmission or distribution of the multicasting information.

35. The communication device according to claim 34, wherein the distribution unit includes a duplication unit or reproduction unit, by means of which the received multicasting information is duplicated or reproduced,
the reproduction unit is configured so that the multicasting information or the reproduced multicasting information is retransmitted substantially simultaneously to at least one output,
the distribution unit is configured so that at least part of the received or reproduced multicasting information is retransmitted to at least one subscriber connection.

36. The communication device according to claim 34, wherein the detection unit is located in the first decentralized communication device for detecting subscriber-connection-specific multicasting information included in the received or reproduced multicasting information, and
a selection unit is assigned to the detection unit, by means of which the subscriber-connection-specific multicasting information is detected in the received or reproduced multicasting information, selected and the selected multicasting information is retransmitted to at least one corresponding subscriber connection.

37. The communication device according to claim 34, wherein the receiving device is configured to receive subscriber-connection-specific useful information also fed to the first and/or to at least a second input,
a device is provided for combining the multicasting information to be transmitted to at least one subscriber connection or the selected multicasting information and the respective subscriber-connection-specific useful information, with the combined information being retransmitted to at least one subscriber connection.

38. The communication device according to claim 34, wherein at least one subscriber connection assigned to the decentralized communication device is configured according to an xDSL transmission technology, with an option of transmitting the information transmitted to at least one subscriber connection via a connectable peripheral line using an xDSL transmission method to a network terminating device assigned to the subscriber connection.

39. The communication device according to claim 34, wherein at least one peripheral communication network can be connected to at least one subscriber connection assigned to the decentralized communication device, with an option of connecting one or more subscribers to at least one subscriber connection via at least one peripheral communication network.

40. The communication device according to claim 39, wherein at least one subscriber connection is configured according to a transmission method corresponding to the synchronous or plesiochronous digital hierarchy and/or according to a packet based and/or cell-based transmission method.

41. The communication device according to claim 40, wherein at least one subscriber connection is configured according to the Asynchronous Transfer Mode or according to Frame Relay or according to a TCP/IP-compliant or an Ethernet-compliant communication network.
